(19) United States
(12) Patent Application Publication
(10) Pub. No.: US 2007/0002411 A1
(43) Pub. Date: Jan. 4, 2007

(54) Image forming apparatus and image processing apparatus

(75) Inventors: Takaaki Sakai, Tokyo (JP); Junji Sato, Tokyo (JP); Akio Ueda, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Konica Minolta Business Technologies, Inc., Tokyo (JP)

(21) Appl. No.: 11/376,015

(22) Filed: Mar. 15, 2006

(30) Foreign Application Priority Data
Jul. 1, 2005 (JP) JP2005-193873

(51) Int. Cl. H04N 1/46

(52) U.S. Cl. 358/540; 358/1.13

(57) ABSTRACT

An image forming apparatus includes: a creating section which creates a multiple-up image to be printed on a sheet from a plurality of document, wherein the multiple-up image having a plurality of marks corresponding to one document and a sheet number corresponding to order of outputting a sheet; and an image printing section which prints the multiple-up image on a sheet.

This application is based on Japanese Patent Application No. 2005-193873 filed on Jul. 1, 2005, which is incorporated hereinto by reference.

### BACKGROUND OF THE INVENTION

This invention relates to an image forming apparatus and an image processing apparatus.

Image forming apparatuses such as copiers and facsimiles which include a function for collecting a prescribed number (collection number) of plural document images, and forming the multiple-up image (also referred to as collected document images) on one sheet of transfer paper and then outputting them are known in the prior art. Furthermore, image forming apparatuses which include a function for inserting a prescribed number such as page number and the like when the multiple-up images are output are also known.

In the abovementioned image forming apparatuses, specifically that shown in FIGS. 21(a) to 21(c)-3, sets of four document images on 12 sheets of documents (documents 101-112) are collected and the multiple-up images (multiple-up images C1, C2, and C3) are formed and output on one sheet of transfer sheet (sheet 810, 820, 830, 910, 920, and 930). Furthermore, along with the multiple-up images, the document pages which are added on the multiple-up images (numbers 811, 821, 831 of “output pattern 1”) or the output order of the multiple-up images (numbers 912, 922, 932 of “output pattern 2”) are formed and output on the transfer paper (See Patent Document 1 for example)

[Patent Document 1] Unexamined Japanese Patent Publication No. 10-173903

However, in the “output pattern 1” of FIGS. 21(b)-1 to 21(b)-3 and the “output pattern 2” of FIGS. 21(c)-1 to 21(c)-3 for example, because it is unclear as to which document image was formed and output on which transfer paper, a problem arises in that the searching for a desired document image and keeping track of the number of output sheets is troublesome.

Specifically, in the “output pattern 1” of FIGS. 21(b)-1 to 21(b)-3, for example, because a number is not added on each sheet of transfer paper, it is difficult to determine which document image is formed and output on which sheet in the output sequence. Furthermore, it is also difficult to determine the total number of output sheets.

In addition, in the “output pattern 2” of FIGS. 21(c)-1 to 21(c)-3 because a number is not added on each document image, it is difficult to determine which number document image of which document page is formed and output on which transfer paper.

### SUMMARY OF THE INVENTION

An object of this invention is to provide an image forming apparatus and an image processing apparatus in which a clearer determination can be made as to which document image was output on which transfer paper.

The Structures (1)-(3) to achieve the above object are described in the following.

Structure (1): An image forming apparatus comprising: a creating section which creates a multiple-up image to be printed on a sheet from a plurality of document, wherein the multiple-up image having a plurality of marks such as page numbers of documents corresponding to one document and a sheet number corresponding to order of outputting a sheet; and an image printing section which prints the multiple-up image on a sheet.

Structure (2): An image forming apparatus comprising: a creating section which creates a multiple-up image to be printed on a sheet from a plurality of document; a mark creating section which creates a plurality of marks such as page numbers of documents corresponding to one document; a sheet number creating section which creates a sheet number corresponding to order of outputting a sheet; a combining section which combines the multiple-up image, the mark and the sheet number to form a composite image; and an image printing section which prints the composite image combined by the combining section on a sheet.

Structure (3): An image processing apparatus comprising: a creating section which creates a multiple-up image to be printed on a sheet from a plurality of document; a mark creating section which creates a plurality of marks such as page numbers of documents corresponding to one document; a sheet number creating section which creates a sheet number corresponding to order of outputting a sheet; and a combining section which combines the multiple-up image, the mark and the sheet number to form a composite image.

### BRIEF DESCRIPTION OF THE DRAWINGS

FIG. 1 is a cross-sectional view showing the inner structure of a copier of the embodiment of this invention.

FIG. 2 is a block diagram showing the functional structure of a copier of the embodiment of this invention.

FIG. 3 shows the main menu screen.

FIG. 4 shows the application function selection screen.

FIG. 5 shows the collection-on-one-sheet mode screen.

FIG. 6 shows the application function selection screen in which “collection-on-one-sheet” is set.

FIG. 7 shows the main menu screen in which “document setting” is set.

FIG. 8 shows the stamp/overlay mode screen.

FIG. 9 shows the page printing mode screen.

FIG. 10 shows the collected page print setting screen.

FIG. 11 shows the collected page printing mode screen.

FIG. 12 shows the application function selection screen in which “stamp and overlay” is set.

FIG. 13 is a flowchart for describing processing related to the reading of the document image at the copier.

FIG. 14 is a flowchart for describing the first processing relating to formation and output of the composite image in the copier.

FIGS. 15(a) to 15(b)-3 are the first drawing for describing the composite image output in the first processing relating to formation and output of the composite image at the copier.

FIGS. 16(a) to 16(b)-3 are the second drawing for describing the composite image output in the first processing relating to formation and output of the composite image at the copier.

FIG. 17 is a flowchart for describing the second processing relating to formation and output of the composite image at the copier.

FIGS. 18(a) to 18(b)-3 are the first drawing for describing the composite image output in the second processing relating to formation and output of the composite image at the copier.

FIGS. 19(a) to 19(b)-3 are the second drawing for describing the composite image output in the second processing relating to formation and output of the composite image at the copier.

FIGS. 20(a)-1 to 20(c)-3 are for describing a modified example of the composite image output in the processing relating to formation and output of the composite image at the copier.

FIGS. 21(a) to 21(c)-3 are for describing a modified example of the composite image output in the processing relating to formation and output of the composite image at the copier of the prior art.

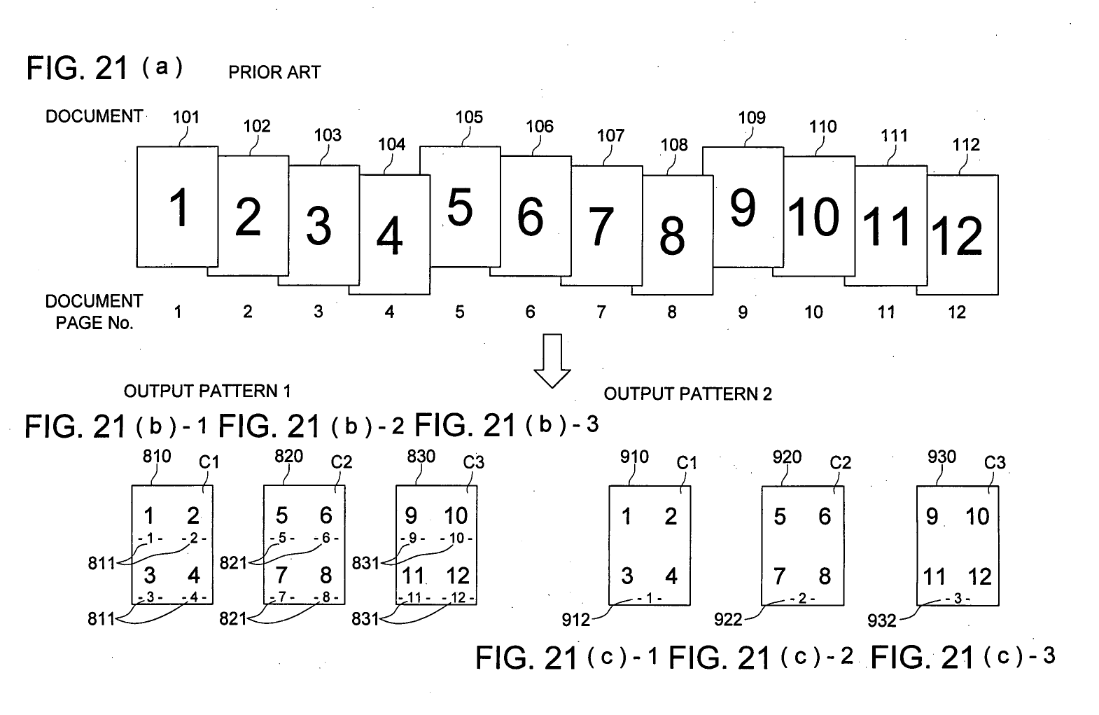

### DETAILED DESCRIPTION OF THE PREFERRED EMBODIMENT

The following is a detailed description of the preferred embodiments of the image forming apparatus and the image processing apparatus of this invention with reference to the drawings. It is to be noted that the examples in the drawings are not intended to limit the scope of the invention.

This embodiment will be described using the copier 1 as the example of the image forming apparatus.

<Structure>

First the structure (internal structure and functional structure) of the copier 1 will be described.

(Internal Structure of the Copier)

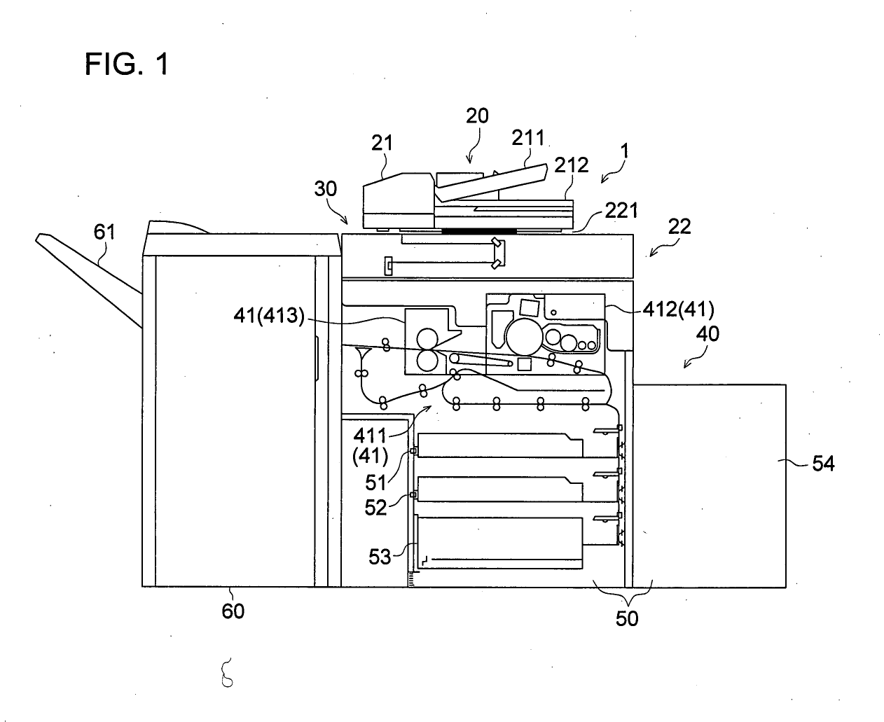

As shown in FIG. 1, the copier 1 may comprise an image reading section 20, an operation section 30, a printer section 40, a sheet feeding unit 50; and a sheet finishing unit 60.

The image reading section 20 comprises an ADF (Automatic Document Feeder) section 21, a scanner section 22 and the like.

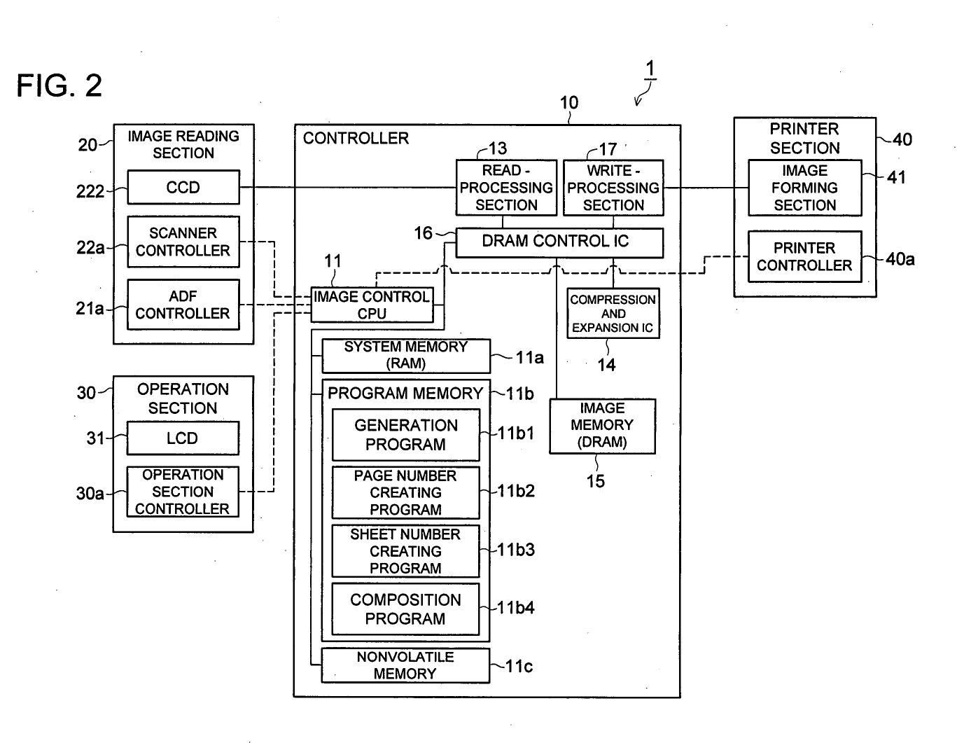

More specifically, as shown in FIG. 2, the ADF section 21 sends the document loaded on the document feeding tray 211 above the document table 221 of the scanner section 22 according to instructions from the ADF controller 21a (described hereinafter). When reading of the document image by scanner section 22 ends, the document is fed to the document discharge tray 212.

The scanner 22 projects a beam onto the document on the document table 221 according to instructions from the scanner controller 22a (described hereinafter). The light reflected by this beam is read by a CCD (Charge Coupled Device) 222 (described hereinafter) and photo-electrically converted analog image signals.

The operation section 30 comprises a LCD (Liquid Crystal Display) 31 (described hereinafter) whose upper surface is covered by a touch panel (not shown, and various operation buttons (not shown).

Specifically, the LCD 31 performs given display processing in accordance with the display signals inputted from the operations section controller 30a (described hereinafter).

The touch panel which covers the upper surface of the LCD 31 (not shown) detects the position on the LCD 31 that is specified manually or by using a dedicated touch panel and this is output to the operation section controller 30a.

Each operation section button (not shown) may for example, have a start button, and press signals corresponding to button operation by the operator are output to the operation section controller 30a.

The printer section 40 comprises an image forming section 41.

More specifically, the image forming section 41 comprises a conveyance mechanism 411 for conveying the transfer paper fed from the paper feeding unit 50; an image writing section 412 for writing images on the transfer paper; and a fixing section 413 for fixing the toner image formed on the transfer paper by applying heat and pressure, and images are formed and output on the transfer paper based on the instructions from the printer controller 40a (described hereinafter).

The image writing section 412 comprises a photoreceptor drum which is the image carrier; the charging section which charges the photoreceptor drum, the exposure section which performs exposure and scanning on the photoreceptor drum surface based on print data; a development section in which toner is applied to the photoreceptor drum; a transfer section in which toner image formed on the photoreceptor drum is transferred onto transfer paper; a cleaning section for removing toner remaining on the photoreceptor drum and the like.

The fixing section 413 comprises heating rollers for heating the transfer paper, pressure rollers for applying pressure to the transfer paper and the like. In the fixing section 413, the transfer paper on which the toner image is formed is passed between the heating roller and the pressure roller and the image is thereby fixed on the transfer paper.

The paper feeding unit 50 comprises trays 51, 52, 53 and 54 for storing the various transfer papers for paper feeding. The trays 51, 52, 53 and 54 can store transfer papers which differ in terms of type (regular paper, recycled paper, high quality paper and the like), size, color, whether they are punched or not.

It is to be noted that the number of trays is not limited to the number shown in FIG. 1 and may be suitably selected. Also, material other than paper such as OHP (Overhead Projector) sheets may also be used.

The post processing unit 60 comprises at least one of a sorting section for sorting the transfer papers on which images have been formed, a cutting section for performing the cutting process, a hole punching section for forming punch holes, and a stapling section for performing the stapling process. The transfer paper on which images have been formed by the printer section 40 is discharged to the discharge tray 61 after being subjected to post-processing in the post-processing unit 60 or alternatively it may be discharged from the discharge tray 61 without being subjected to post-processing.

(Functional Structure of Copier)

As shown in FIG. 2, the copier 1 may for example comprise the controller 10 which is the image processing apparatus, the image reading section 20, the operation section 30 and the printer section 40 and the like.

The controller 10 comprises: an image control CPU 11; a system memory 11a, a program memory 11b, a nonvolatile memory 11c; a read-processing section 13; compression and expansion IC (Integrated Circuit) 14; image memory 15; DRAM (Dynamic Random Access Memory) control IC 16; write-processing section 17 and the like.

The CPU 11 performs various control operations based on the various processing program for the copier 1 that are stored in the program memory 11b.

The system memory 11a may for example, be formed of RAM (Random Access Memory), and includes a program storage region for opening processing programs that are executed by the image control CPU 11 and a data storage region for storing input data or processing results generated when the processing programs are executed.

The program memory 11b stores the system programs that can be executed at the copier 1, and the various processing programs that can be executed by the system program. It is to be noted that the programs are stored in the program memory 11b in a program code format that is readable by the computer.

Specifically, as shown in FIG. 2 for example, a generation program 11b1, a page number creating program 11b2, a sheet number creating program 11b3, a composition program 11b4 and the like can be stored in the program memory 11b.

The generation program 11b1 realizes the function for generating multiple-up image (also referred to as collected document images) in which a preset collection number of multiple document images.

The image control CPU 11 functions as the generation means by executing the generation program 11b1.

The page number creating program 11b2 realizes the function of performing settings for inserting a mark, for example, a page number corresponding to the document page of the document image on each document image in the multiple-up images generated by the image control CPU 11 that executed the generation program 11b1 in the image control CPU 11.

The image control CPU 11 functions as page number creating section by executing the page number creating program 11b2.

The sheet number creating program 11b3 realizes the function of performing settings for inserting a sheet number corresponding to the order in which the multiple-up images are formed on the transfer paper and output, onto the multiple-up images generated by the image control CPU 11 that executed the generation program 11b1 in the image control CPU 11.

Specifically, the image control CPU 11 executes the sheet number creating program 11b3 and settings are performed for inserting the transfer paper number onto one position of the multiple-up images or to each of the document images in the multiple-up images.

The CPU 11 functions as a sheet number creating section, a first sheet number creating section, a second sheet number creating section by executing the sheet number creating section program 11b3.

The composition program 11b4 realizes the function for composing composite images comprising multiple-up images in which a preset collection number of multiple document images; page numbers corresponding to the document page of the document image, and a sheet number corresponding to the order in which the multiple-up images are formed on the transfer paper and output, in the image control CPU 11.

More specifically, the image control CPU 11 executes the composition program 11b4, and composes a composite image in which the page number that is set by the image control CPU 11 that executed the page number creating program 11b2 and the sheet number that is set by the image control CPU 11 that executed the sheet number setting program 11b3, are inserted onto the collected image documents generated by the image control CPU 11 that executed the generation program 11b1.

The image control CPU 11 functions as composition means by executing the composition program 11b4.

The nonvolatile memory 11c is formed from at least flash memory on which data can be written and may store data such as that used when the image control CPU 11 executes the various processing programs stored in the program memory 11b, and data from processing results that are computed by the control CPU 11.

The read processing section 13 generates digital image data by subjecting the analog image signals input from the CCD 222 (described below) of the image reading section 20 to various processing such as analog processing and shading and then performing A/D conversion. The generated image data is then output to the DRAM control IC 16.

The compression and expansion IC 14 subjects the image data to compression or expansion based on instruction from the DRAM control IC 16.

The image memory 15 is formed from DRAM, and is memory for storing the image data (compressed image data or uncompressed image data) and the like that is input from the DRAM control IC 16 according to instructions from the DRAM control IC 16.

The DRAM control IC 16 controls the compression and expansion IC 14 according to instructions from the image control CPU 11 and also controls input and output of image data to the image memory 15.

Specifically, if for example, instructions are given from the image control CPU 11 for the image data of the document image read by the image reading section 20 to be compressed and stored, the DRAM control IC 16 outputs the image data input from the read processing section 13 to the compression and expansion IC 14, and controls the compression and expansion IC 14 to perform compression processing on the image data. The DRAM control IC 16 then stores the image data that has been subjected to compression processing (compressed image data) in the image memory 15.

On the other hand, if for example, instructions are given from the image control CPU 11 for the image data of the document image read by the image reading section 20 to be stored without being compressed, the DRAM control-IC 16 stores the image data (uncompressed image data) input from the read processing section 13 in the image memory 15.

In addition, if for example, instructions are given from the image control CPU 11 for image formation and output based on compressed image data stored in memory 15, the DRAM control IC 16 obtains the compressed image data from the image memory 15 and outputs it to the compression and expansion IC 14 to control the compression and expansion IC 14, and thereby subject the compressed image data to expansion processing. The expanded image data is then temporarily stored in the image memory 15 and output to the write-processing section 17 at a prescribed timing.

Meanwhile, if instructions are given from the image control CPU 11 for image formation and output based on the uncompressed image data stored in the image memory 15, the DRAM control IC 16 obtains the uncompressed image data from the image memory 15 and outputs it to the write-processing section 17 at a prescribed timing.

The write-processing section 17 generates a print table for image formation based on image data that has been input from the DRAM control IC 16, and subjected to image processing such as enlargement, reduction, rotation, positional changes and the like by the image control CPU 11, and outputs it to the image forming section 41 of the printer section 40.

The image reading section 20 comprises a CCD 222, a scanner controller 22a, and an ADF controller 21a.

The scanner controller 22a and the ADF controller 21a control the scanner section 22 and the ADF section 21 respectively, according to instructions from the image control CPU 11.

The CCD 222 photo-electrically converts the reflected light from the light projected on the document on the document table 221 to analog image signals in accordance with instructions from the scanner controller 22a and outputs the signals to the read-processing section 13 of the controller 10.

The operation section 30 comprises a LCD 31 whose upper surface is covered by a touch panel (not shown); operation section controller 30a; and various operation buttons (not shown).

Specifically, operation section controller 30a controls the LCD 31 according to instructions from the image control CPU 11. The operation section controller 30a also outputs signals input from the touch panel (not shown) or the various operation buttons (not shown) and the like to the image control CPU 11.

More specifically, the touch panel (not shown) of the operation section 30 uses as a selecting section a method in which the operator sets the sheet number using the image control CPU 11 which executed the sheet number creating program 11b3, or in other words, settings for inserting the sheet number to one position on the collected document image, or settings for inserting the sheet number to each document image in the collected document image at the time of selection.

In addition, the touch panel (not shown) of the operation section 30 may be used for example, as an insertion position selecting section which is used when the operator selects the attachment position for the sheet number using the image control CPU 11 in which composition program 11b4 is executed.

The printer section 40 comprises an image forming section 41 and a printer controller 40a, and it functions as an image formation and output means by forming the composite image composed by the image control CPU 11 which executed the composition program 11b4 on the transfer paper and outputting the image.

The printer controller 40a controls the image forming section 41 according to instructions from the image control CPU 11.

The image forming section 41 forms images based on the print data input from the write-processing section 17 on the transfer paper in accordance with instructions from the print controller 40a and outputs the transfer paper.

It is to be noted that the output system in the printer section 40 may be any type such as inkjet, thermal transfer, laser, sublimation, or TA (Thermo-Autochrome) system.

<Processing>

Next, the processes of the copier 1 such as the “Collection method setting processing”, the “Page number and sheet number creating processing”, the “Document image reading processing”, the “First composite image formation and output processing” and the “Second composite image formation and output processing will be described”.

(Collection Method Setting Processing)

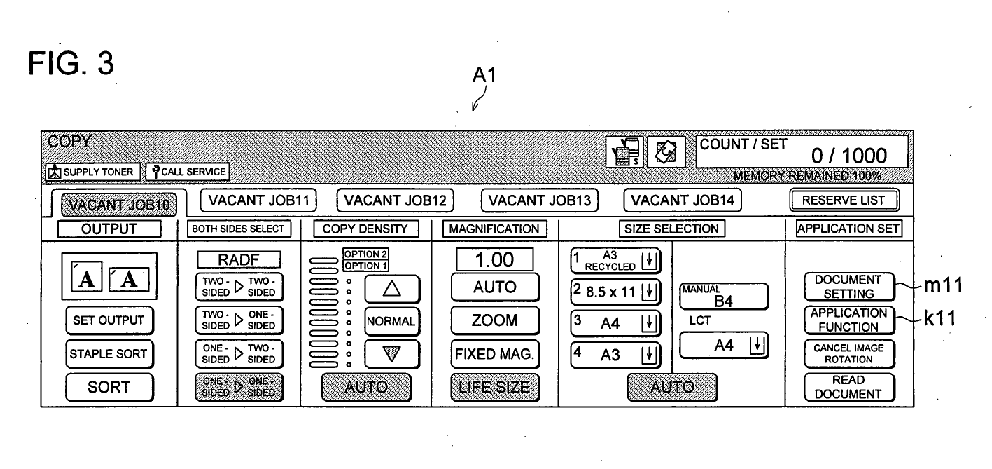

First, the processing relating to the setting of the collection method in the copier 1 will be described with reference to FIG. 3 to FIG. 7.

When the power source for the copier 1 is turned on, the image control CPU 11 sends instructions to the operation section controller 30a of the operation section 30, and the main menu screen A1 such as that shown in FIG. 3 is displayed on the LCD 31.

Specifically, the “Application function” key k11 and the “Document setting” m11 for example, may be displayed at the main menu screen A1.

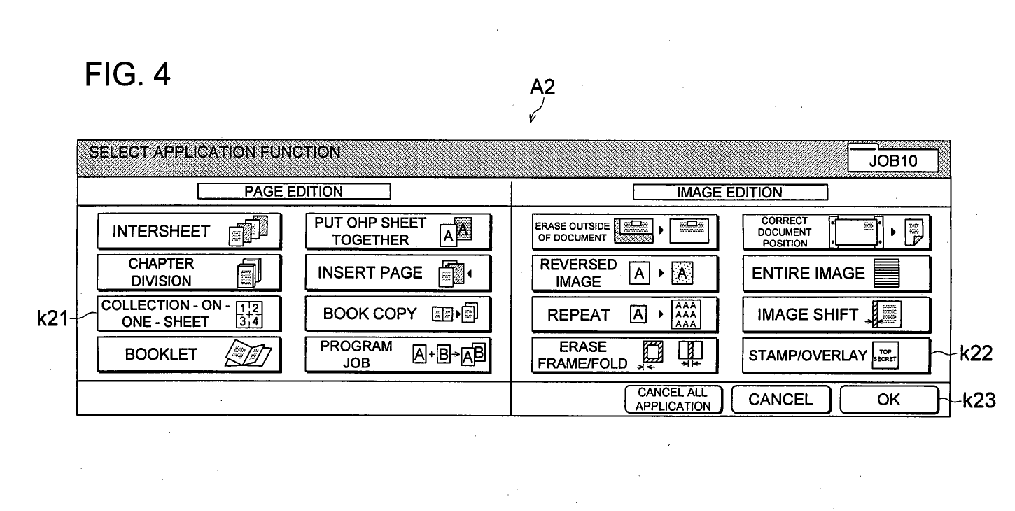

Next, when the “Application function” key k11 is pressed, the image control CPU 11 displays the application function setting screen A2 such as that shown in FIG. 4 on the LCD 31.

More specifically, the “collection-on-one-sheet” key k21, the “stamp and overlay” key k22 and the “OK” key k23 and the like are displayed at the application function setting screen A2.

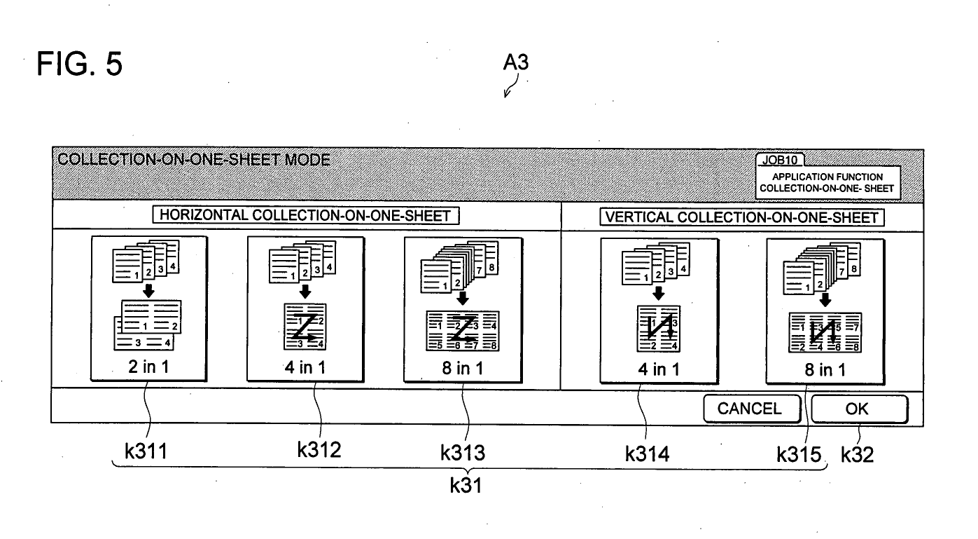

Next when the “collection-on-one-sheet” key k21 is pressed, the image control CPU 11 displays the collection-on-one-sheet mode screen A3 shown in FIG. 5 on LCD 31. The collection method (number of documents to be collected and the like) can be set at the collection-on-one-sheet mode screen A3.

Specifically, various keys such as the “collection mode selection” keys k31 and the “OK” key k32 are displayed at the collection-on-one-sheet mode screen A3.

More specifically, if the “two-in-one” key k311 is selected from among the various “collection mode selection” keys k31, the copier 1 prints the collected document image in which is arranged “2” document images, which is the number of documents to be collected that is displayed at the selected key.

Also, if the “four-in-one” key k312 or the “four-in-one” key k314 is selected from among the various “collection mode selection” keys k31, the copier 1 prints the collected document image in which is arranged “4” document images, which is the number of documents to be collected that is displayed at the selected key.

Furthermore, if the “eight-in-one” key k313 or the “eight-in-one” key k315 is selected from among the various “collection mode selection” k31, the copier 1 prints the collected document image in which is arranged “8” document images, which is the number of documents to be collected that is displayed at the selected key.

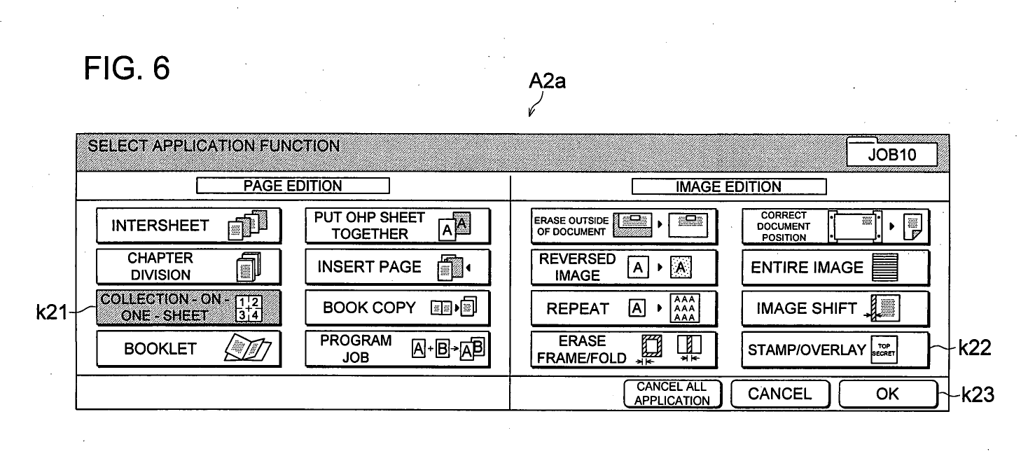

Next, if any one of the various “collection mode selection” keys k31 is selected and subsequently the “OK” key k32 is pressed, and the image control CPU 11 displays on LCD 31, the application function selection screen A2a in which “collection-on-one-sheet” has been set as shown in FIG. 6.

Specifically, at the application function selection screen A2a in which “collection-on-one-sheet” has been set, the “collection-on-one-sheet” key k21 is displayed in a different form than the “collection-on-one-sheet” key k21 of the application function selection screen A2 (FIG. 4).

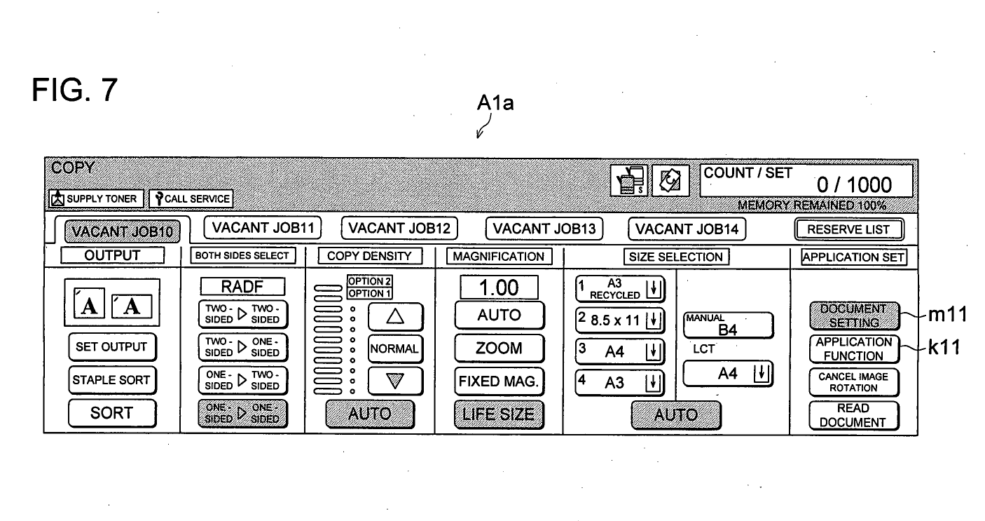

Next, if the “OK” key k23 of the application function selection screen A2a (FIG. 6) in which “collection-on-one-sheet” has been set is pressed, the image control CPU 11 displays on LCD 31, the main menu screen A1a in which the “document setting” is set as shown in FIG. 7 and this processing ends.

Specifically, on the main menu screen A1a in which the “document setting” is set, a “document setting” m11 is displayed in a different form than the “document setting” m11 of the main menu screen A1 (FIG. 3).

(Page Number and Sheet Number Creating Processing)

Next, the processing relating to page number and sheet number setting in the copier 1 will be described with reference to FIG. 3, FIG. 4, FIG. 7 and FIG. 8 to FIG. 12.

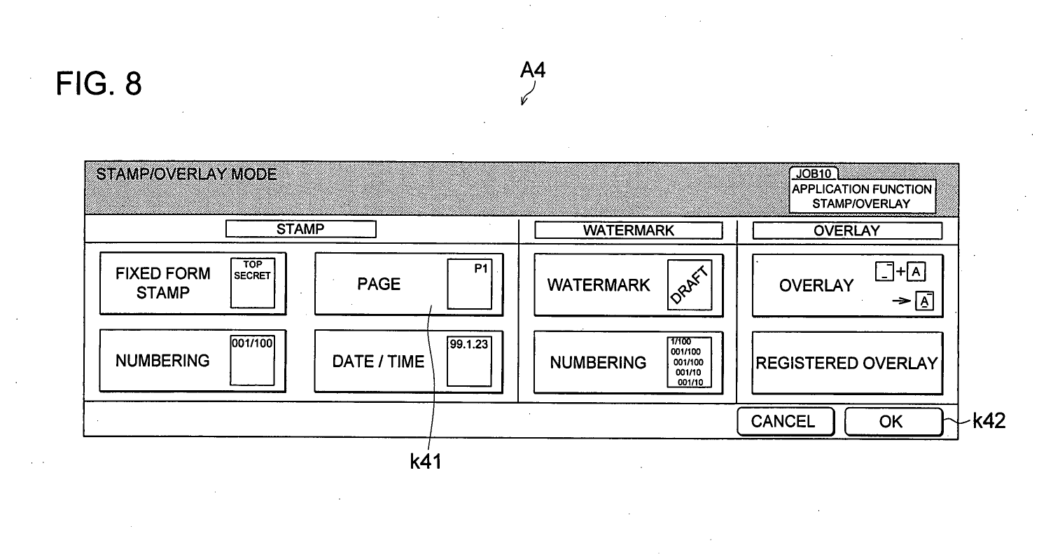

When the “application function” key k11 of the main menu screen A1 (FIG. 3) is pressed, and then the “stamp and overlay” key k22 of the application function selection screen A2 (FIG. 4) is pressed, the image control CPU 11 sends instructions to the operation section controller 30a of the operation section 30 and the stamp and overlay mode screen A4 such as that shown in FIG. 8 is displayed on the LCD 31.

Specifically, the “page” key k41 and the “OK” key k42 for example, are displayed in the stamp and overlay mode screen A4.

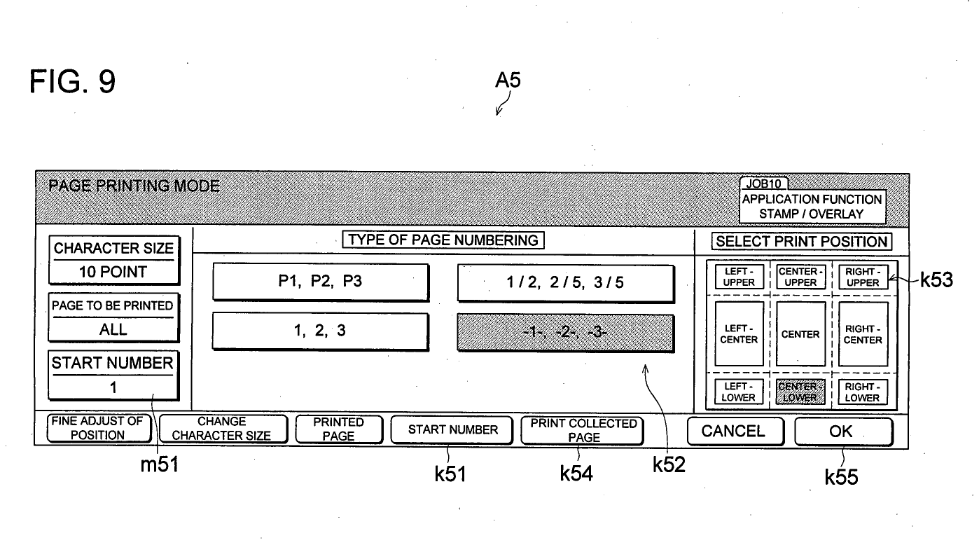

Next, if the “page” key k41 is pressed, the image control CPU 11 displays the page print mode screen A5 such as that shown in FIG. 9 at the LCD 31. The start number for the page number, the display method and print position can be set at the page print mode screen A5.

Specifically, at the page print mode screen A5, keys such as the “start number” key k51, various “type of page numbering” keys k52, various “print position selection” keys k53, “collected pages” print key k54 and the “OK” key k55 are displayed.

More specifically, the operator may set the start number for page number by pressing the “start number” key k51 for example. In FIG. 9, the start number for page number may be set to “1” for example as shown by the “start number” m51.

The operator can set the page number display method by pressing any one of the various “type of page numbering” keys k52. In FIG. 9 for example, the page number display method is set to “-1-, -2-, -3-”.

Also the operator can set the print position of the page number by pressing one of the various “print position selection” keys 53. In FIG. 9 for example, the print position of the page number is set to “center-lower”.

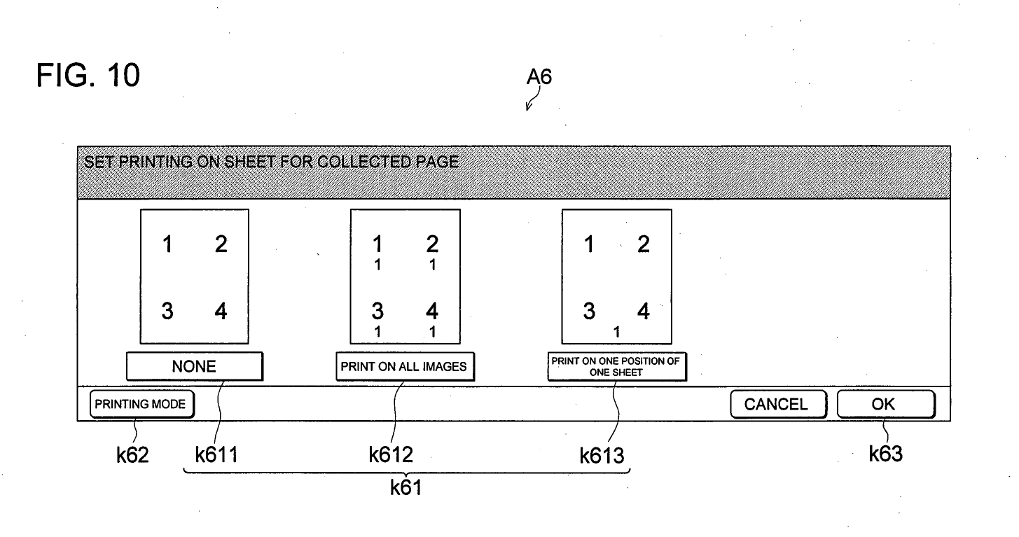

Next, if the start number for page number the display method, the print position and the like are set and then the “collected page print” key k54 is pressed, the image control CPU 11 displays the collected page print setting screen A6 such that shown in FIG. 10 on the LCD 31. In this collected page print setting screen A6, the number of sheets to be printed is set.

Specifically, the collected page print setting screen A6 displays the various “number of print times” keys k61, the “print mode” key k62, and the “OK” key k63.

More specifically, when for example, the “none” key k611 is selected from among various “number of print times” keys k61, the copier 1 does not print the sheet number.

If for example, the “print on all images” key k612 is selected from among various “number of print times” keys k61, the copier 1 prints the sheet number on the collected number of sheets on one sheet of transfer paper.

In addition, when for example, the “print on one position of one sheet” key k613 is selected from among various “number of print times” keys k61, the copier prints one sheet number on one sheet of transfer paper.

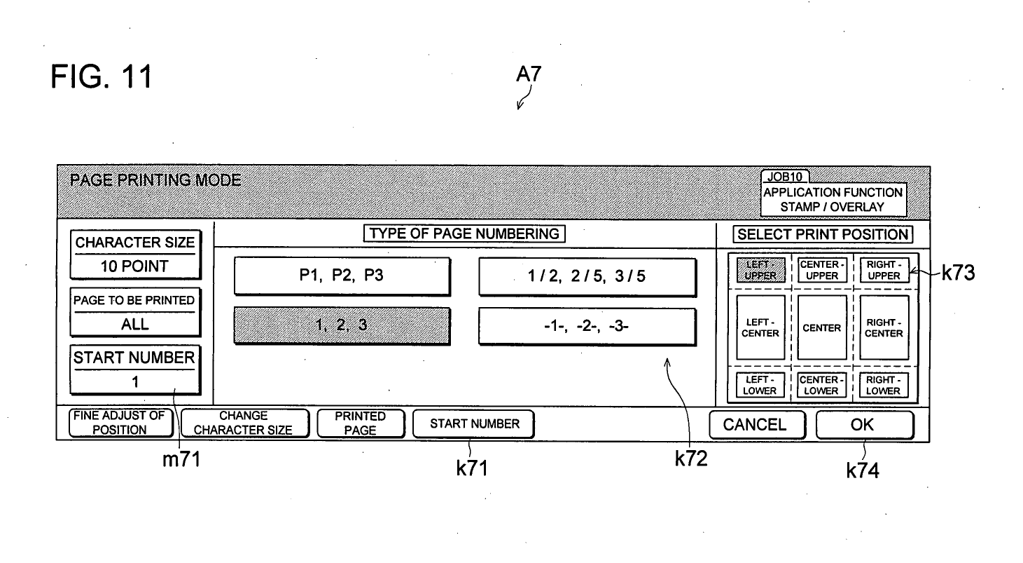

Next, when any of the “number of print times” keys k61 is pressed and the “print mode key” k62 is pressed, the image control CPU 11 displays collected page print mode screen A7 such as that shown in FIG. 11 on the LCD 31. In this collected page print mode screen A7, the start number for the sheet number, the display method, the print position (position where number is inserted) and the like is set.

Specifically, in the collected page print mode screen A7, the “start number” key k71, the various “type of page numbering” keys k72, various “print position selection” keys 73 and the OK key k74 and the like are displayed.

More specifically, the operator may set the start number for the sheet number by pressing the “start number” key k71 for example, in FIG. 11, the start number for the sheet number is “1” as shown in the “start number” m71.

The operator can set the display method for the sheet number by pressing one of the “type of page numbering” keys k72. For example in FIG. 11, the display method for sheet number is set to “1, 2, 3”.

Also the operator can set the print position for the sheet number (insertion position), by selecting one of the various “print position selection” keys k73. For example in FIG. 11, the print position for the sheet number is set to “left upper”.

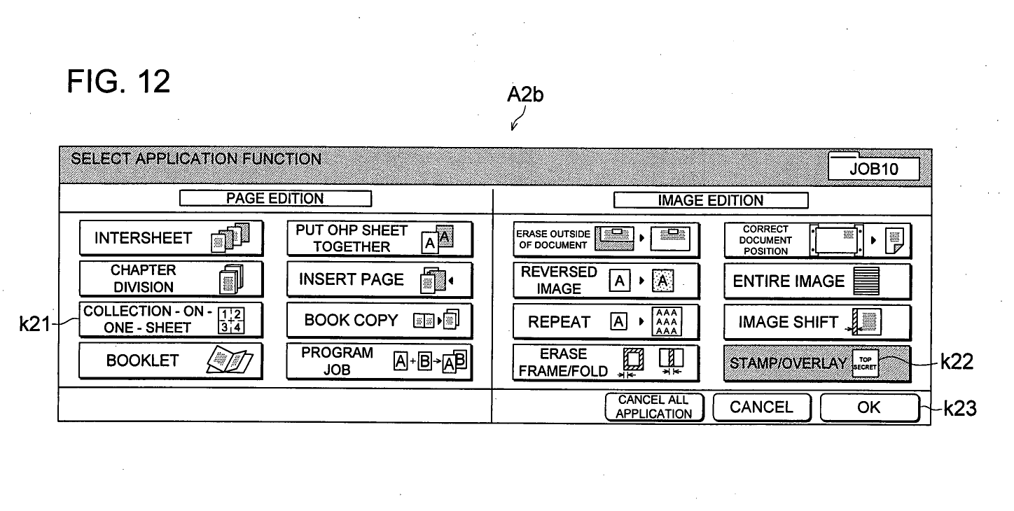

Next when the start number for the sheet number, the display method and the print position (insertion position) and the like are set and then the “OK” key k74 is pressed, the image control CPU 11 displays the application function selection screen A2b in which the stamp and overlay is set, such as that shown in FIG. 12 on the LCD 31.

Specifically, in the application function selection screen A2b in which the stamp and overlay is set, the “stamp and overlay” key k22 is displayed in a different form than the “stamp and overlay” key k22 of the application function selection screen A2 (FIG. 4).

Next, if the “OK” key k23 of the application function selection screen A2b (FIG. 12) in which the stamp and overlay is set, is pressed, the image control CPU 11 displays the main menu screen A1a (FIG. 7) in which “document setting” is set on the LCD 31, and this processing ends.

(Document Image Read Processing)

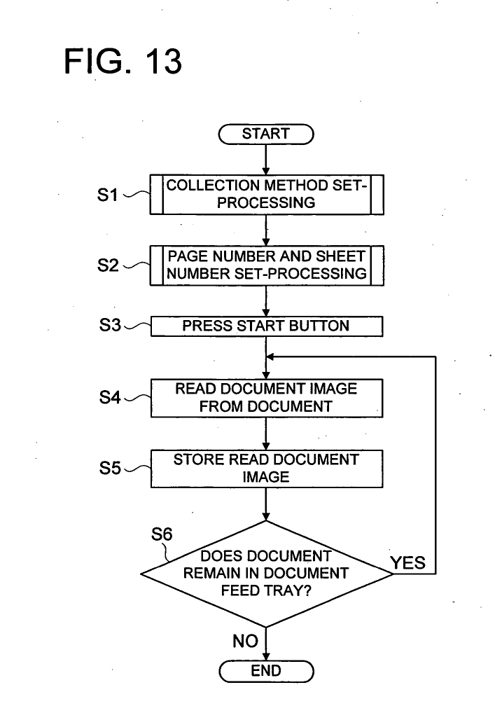

Next, the processing related to the reading of the document image in the copier 1 will be described with reference to the flowchart in FIG. 13.

First, the processing related to the setting of the collection method in the copier 1 which was described above (Collection method set-processing) is carried out (Step S1) and then the processing relating to the setting of the page number and the sheet number in the copier 1 (Page number and sheet number set-processing) are carried out (Step S2). When the “Start” button is pressed from among the various operation buttons (not shown) in the operation section 30 (Step S3), and the image control CPU 11 sends instructions to the ADF controller 21 of the image reading section 20, and at the ADF section 21 the documents loaded on the document feeding tray 211 are sent onto the document table 221 of the scanner section 22. Instructions are then sent to the scanner controller 22a of the image reading section 20, and the document images are read from the documents that were sent onto the document table 221 at the scanner section 22 (the CCD 222 of the scanner section 22) (Step S4).

Next the image control CPU 11 sends instructions to the DRAM control IC 16 and the document that was read in Step S4 (the image data from the document image read in Step S4) is stored in the image memory 15 (Step S5).

Next, the image control CPU 11 determines whether there are documents remaining in the document feed tray 211 via the ADF controller 21a (Step S6).

In Step S6, if a determination is made that documents remain in document feeding tray 211 (Yes in Step S6), the image control CPU 11 repeats the processing from Step S4.

On the other hand, a determination is made that no documents remain in document feeding tray 211 (No in Step S6), the image control CPU 11 ends the processing.

(First Composite Image Formation and Output Processing)

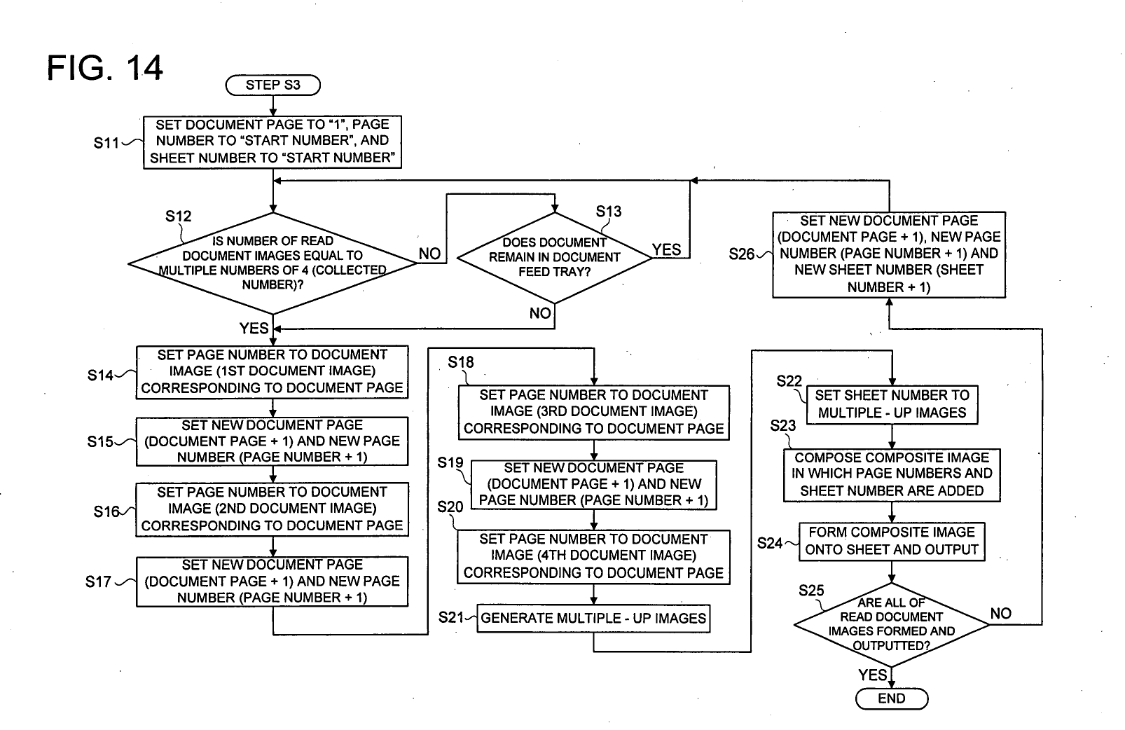

Next, the first processing relating to the formation and output of composite images in the copier 1 will be described with reference to the flowchart in FIG. 14.

In the first processing, the number of collected documents may be set to “4” for example, and also the setting may be such that one sheet number is printed on one sheet of transfer paper.

Specifically, in the collection-on-one-sheet mode screen A3 (FIG. 5) that is displayed in the collection method set processing (Step S1 in FIG. 13), for example, the “four-in-one” key k312 was selected from among the various “collection mode selection” keys k31.

In addition, in the page print mode screen A5 (FIG. 9) that is displayed in the page number set processing (Step S2 in FIG. 13), the start number is set to. “1”, and “-1-, -2-, -3-” is selected from among various “type of page numbering” keys k52, and “center lower” is selected from various “print position selection” keys k53.

Also, in the collected page print setting screen A6 (FIG. 10), that is displayed in the sheet number set processing (Step S2 in FIG. 13), “print on one position of one sheet” key k613 is selected from among various “number of print times” keys k61. Further, in the collected page print mode screen A7 (FIG. 11) that is displayed in the sheet number set processing (Step S2 in FIG. 13), the start number is set to “1”, “1, 2, 3” is selected from among the various “type of page numbering” keys k72, and “left upper” is selected from among the various “print position selection” keys k73.

First when the processing of Step S1-Step S3 (FIG. 13) is performed, the image control CPU 11 sets the document page to “1”, and the page number is set to start number (“1” for example), and sheet number is set to start number “1” for example (Step S11).

Next, the image control CPU 11 makes a determination as to whether the number of document images read in Step S4 (FIG. 13) is a multiple of “4 (collected number)” (Step S12).

If a determination is made in Step S12 that the number of document images read is a multiple of “4 (collected number)” (Yes in Step S12), the image control CPU 11 goes on to the processing of Step S14.

On the other hand, if a determination is made in Step S12 that the number of document images read is not a multiple of “4 (collected number)” (No in Step S12), the image control CPU 11 makes a determination as to whether there are documents remaining in the document feed tray 211 via the ADF controller 21a (Step S13).

In Step S13, if a determination is made that there are documents remaining in the document feed tray 211 (Yes in Step S13), the image control CPU 11 repeats the processing from Step S12.

On the other hand, if a determination is made that there are no documents remaining in the document feed tray 211 (No in Step S13), the image control CPU 11 executes the page number creating program 11b2, and performs the setting for inserting the page number set at Step S11 (or Step S26) onto the document images (called first document images hereinafter) corresponding to the document pages set at Step S11 (or Step S26) from among the document images stored in the image memory 15 at the Step S5 (FIG. 13) (Step S14).

Next, the image control CPU 11 adds “1” to the document page and the page number set in Step S11 (or Step S26), and the new document page and the page number are thereby set (Step S15).

Next, the image control CPU 11 executes the page number creating program 1b2, and performs the setting for inserting the page number set at Step S15 onto the document image (called second document image hereinafter) corresponding to the document page set at Step S15 from among the document images stored in the image memory 15 (Step S16).

Next, the image control CPU 11 adds “1” to the document page and the page number set in Step S15, and the new document page and the page number are thereby set (Step S17).

Next, the image control CPU 11 executes the page number creating program 1b2, and performs the setting for inserting the page number set at Step S17 onto the document image (called third document images hereinafter) corresponding to the document page set at Step S17 from among the document images stored in the image memory 15 (Step S18).

Next, the image control CPU 11 adds “1” to the document page and the page number set in Step S17, and the new document page and the page number are thereby set (Step S19).

Next, the image control CPU 11 executes the page number creating program 11b2, and performs the setting for inserting the page number set at Step S19 onto the document image (called fourth document image hereinafter) corresponding to the document page set at Step S17 from among the document images stored in the image memory 15 (Step S20).

Next, the image control CPU 11 executes the generation program 11b1 and obtains document images which are the first document image, the second document image, the third document image and the fourth document image from the image memory 15 via the DRAM control IC 16, and generates the multiple-up images in which the first to fourth document images are collected (Step S21).

Next the image control CPU 11 executes the sheet number creating program 11b3 and performs the setting for inserting the sheet number set at Step S11 (or Step S26) onto the multiple-up images generated at Step S21 (Step S22).

Next, the image control CPU 11 executes the composition program 11b4, and composes composite images in which the page number and the sheet number are inserted on the multiple-up images (Step S23).

Specifically, the composite image that was composed at Step S23 includes; a collected document image that was generated at Step S22; a page number inserted on the first document image of the multiple-up images (page number set at Step S14); a page number inserted on the second document image of the multiple-up images (page number set at Step S16); a page number inserted on the third document image of the multiple-up images (page number set at Step S18); a page number inserted on the fourth document image of the multiple-up images (page number set at Step S20); and a sheet number inserted on the multiple-up images (sheet number set at Step S22).

Next, the image control CPU 11 outputs the composite image composed in Step S23 to the image forming section 41 of the printer section 40 via the write processing section 17, and then sends instructions to the printer controller 40a and then the composite image is formed on the transfer paper at the image formation section 41 and then output (Step S24).

Next the image control CPU 11 makes a determination as to whether all the document images that were read in Step S4 (FIG. 13) have been formed and output (Step S25).

If a determination is made in Step S25 that not all the document images that were read have been formed and output (No in Step. S25), the image control CPU 11 adds “1” to the document page and the page number set in Step S19 and the sheet number set in Step S11 (or in Step S26) respectively, and the new document page, page number and sheet number are thereby set (Step S26), and repeats the processing from Step S12.

On the other hand if a determination is made in Step S25 that all the document images that were read have been formed and output (Yes in Step S25), the image control CPU 11 ends the processing.

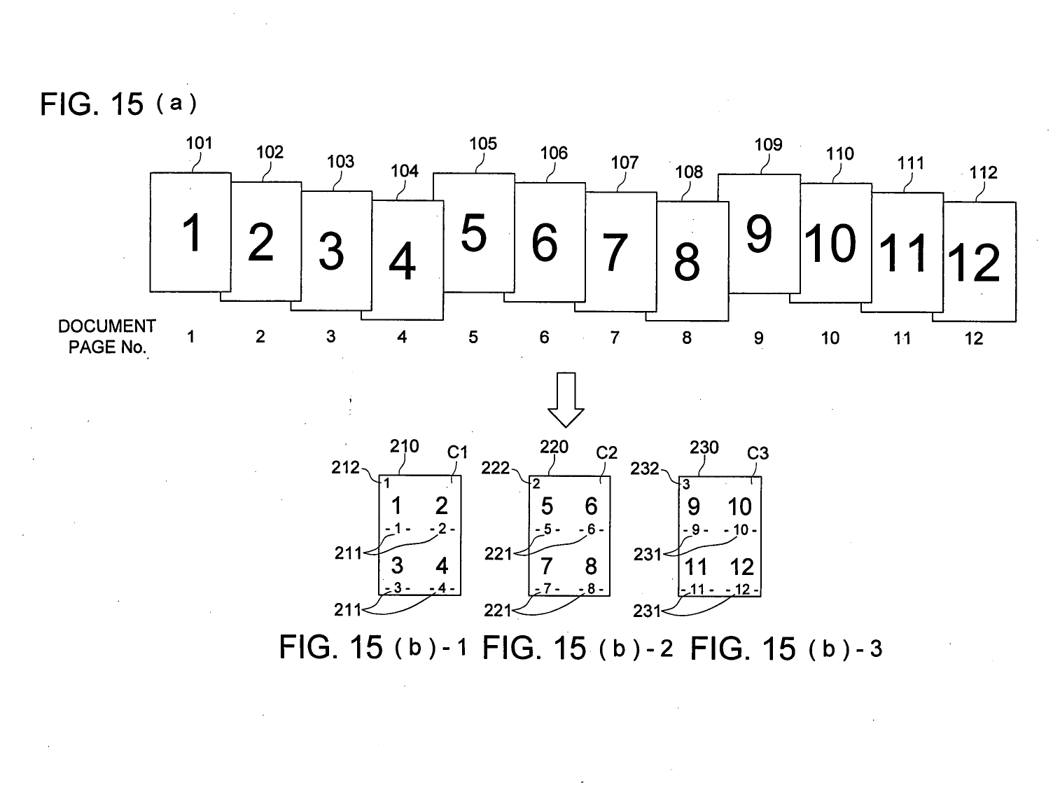

If for example, the document images are read from the documents shown in FIG. 15(a) (documents 101-112) in Step S4 (FIG. 13), transfer paper (sheets 210, 220 and 230) on which composite images such as those shown in FIGS. 15(b)-1 to 15(b)-3 are printed, are output in the first processing (FIG. 14) relating to the formation and output of composite images in the copier 1.

Specifically, in the FIGS. 15(b)-1 to 15(b)-3, marks, for example, page numbers (page number 211, 221, 231) corresponding to the document page of the document image are inserted on the document images of the multiple-up images (multiple-up images C1, C2, C3). Further, sheet numbers (sheet numbers 212, 222, 232) are inserted corresponding to the order in which the multiple-up images are formed on the transfer paper and output, are inserted at one positions of the multiple-up images (multiple-up images C1, C2, C3).

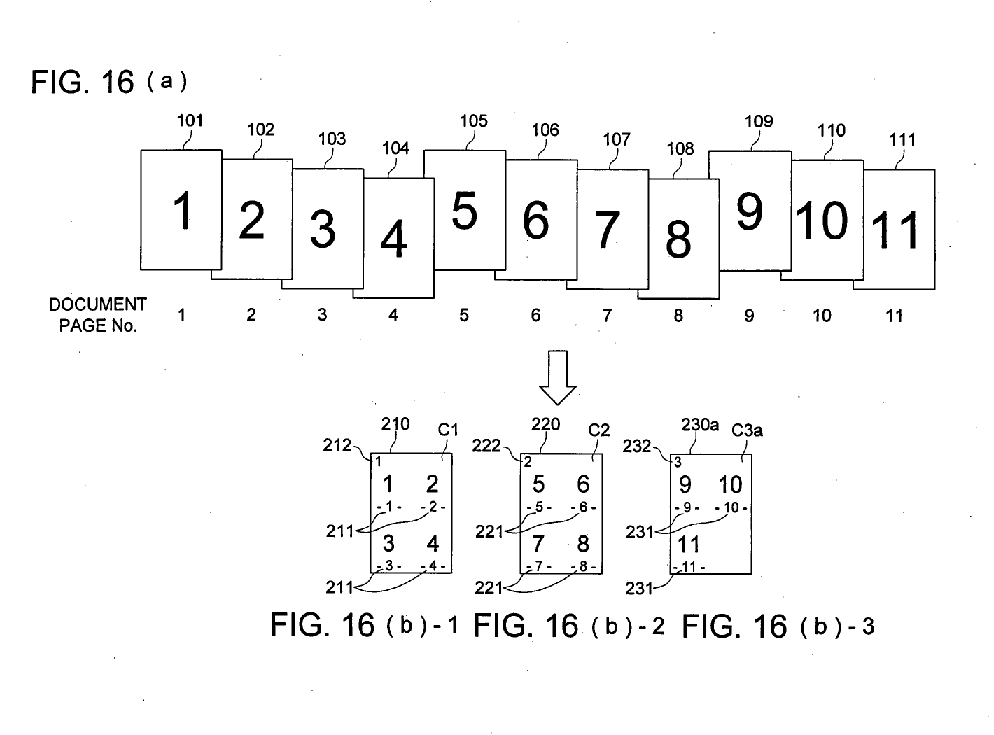

In addition if the document images are read from the documents shown in FIG. 16(a) (documents 101-111) in Step S4 (FIG. 13), transfer paper (sheets 210, 220 and 230a) on which composite images such as those shown in FIGS. 16(b)-1 to 16(b)-3 are printed, are output in the first processing (FIG. 14) relating to the formation and output of composite images in the copier 1.

It is to be noted that in FIG. 16(a) the number of document images is not a multiple of “4 (collected number). That is to say, the number of document images is “11” and because the number document images corresponding to document page “12” does not exist, the processing of Step S19 and Step S20 are omitted in the first processing (FIG. 14) related to the formation and output of the composite image in a copier 1, and in the processing of Step S21, the multiple-up images in which the first to third document images are collected is generated.

Specifically, in FIGS. 16(b)-1 to 16(b)-3, page numbers (page number 211, 221, 231) corresponding to the document page of the document image are inserted on the document images of the multiple-up images (multiple-up images C1, C2, C3a). Further, sheet numbers (sheet numbers 212, 222, 232) corresponding to the order in which the multiple-up images are formed on the transfer paper and output, are inserted at one positions of the collected document image (multiple-up images C1, C2, C3a)

(Second Composite Image Formation Output Processing)

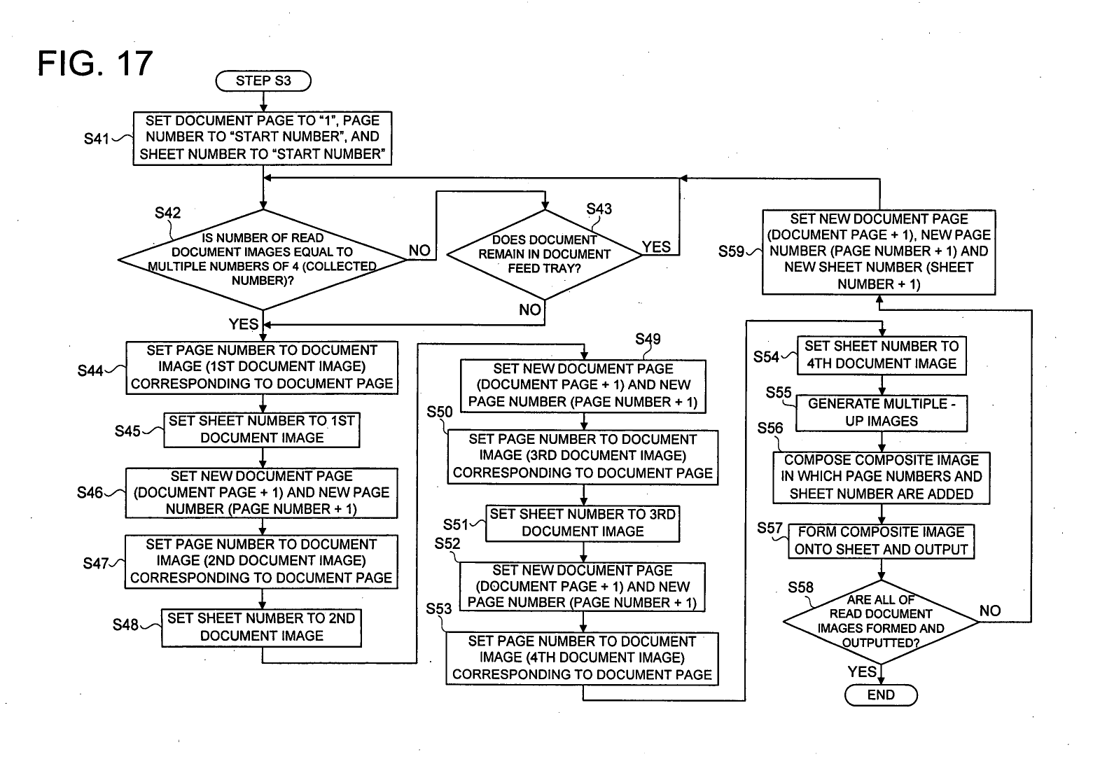

Next, the second processing relating to the formation and output of composite images in the copier 1 will be described with reference to the flowchart in FIG. 17.

In the second processing, the number of collected documents may be set to “4” for example, and also the setting may be such that sheet numbers of the collected number is printed on one sheet.

Specifically, in the collection-on-one-sheet mode screen A3 (FIG. 5) that is displayed in the collection method set processing (Step S1 in FIG. 13), the “four-in-one” key k312 was selected from among the various “collection mode selection” keys k31.

In addition, in the page print mode screen A5 (FIG. 9) that is displayed in the page number set processing (Step S2 in FIG. 13), the start number was set to “1”, and “−1-, 2-3-” was selected from among various “type of page numbering” keys k52, and “center lower” is selected from various print position selection” keys k53.

Also, in the collected page print setting screen A6 (FIG. 10), that is displayed in the sheet number set processing (Step S2 in FIG. 13), “print on all images” key k613 is selected from among various “number of print times” keys k61. Further, in the collected page print mode screen A7 (FIG. 11) that is displayed in the sheet number set processing (Step 2 in FIG. 13), that the start number is set to “1”, and “1, 2, 3” is selected from among the various “type of page numbering” keys k72, and “left upper” is selected from among the various “print position selection” keys k73.

First when the processing of Step S1 to Step S3 (FIG. 13) is carried out, the image control CPU 11 sets the document page to “1”, the page number to start number (such as “1”) and sheet number to start number (such as “1”) (Step S41).

Next, the image control CPU 11 makes a determination as to whether the number of document images read in Step S4 (FIG. 13) is a multiple of “4 (collected number)” (Step S42).

If a determination is made in Step S42 that the number of document images read is a multiple of “4 (collected number)” (Yes in Step S42), the image control CPU 11 goes on to the processing of Step S44.

On the other hand, if a determination is made in Step S42 that the number of document images read is not a multiple of “4 (collected number)” (No in Step S42), the image control CPU 11 makes a determination as to whether there are documents remaining in the document feed tray 211 via the ADF controller 21a (Step S43).

In Step S43, if a determination is made that there are documents remaining in the document feed tray 211 (Yes in Step S43), the image control CPU 11 repeats the processing from Step S42.

On the other hand, if a determination is made in Step S43 that there are no documents remaining in the document feed tray 211 (No in Step S43), the image control CPU 11 executes the page number creating program 11b2, and performs the setting for inserting the page number set at Step S41 (or Step S59) onto the document images (called first document images hereinafter) corresponding to the document pages set at Step S41 (or Step S59) from among the document images stored in the image memory 15 at the Step S5 (FIG. 13) (Step S44).

Next, the image control CPU 11 executes the sheet number creating program 11b3, and performs the setting for inserting the sheet number set at Step S41 (or Step 59) onto the first document image (Step S45).

Next, the image control CPU 11 adds “1” to the document page and the page number set in Step S41 (or Step 59), and the new document page and page number are thereby set (Step S46).

Next, the image control CPU 11 executes the page number creating program 11b2, and performs the setting for inserting the page number set at Step S46 onto the document image (called second document image hereinafter) corresponding to the document page set at Step S46 from among the document images stored in the image memory 15 (Step S47).

Next, the image control CPU 11 executes the sheet number creating program 11b3, and performs the setting for inserting the sheet number set at Step S41 (or Step 59) onto the second document image (Step S48).

Next, the image control CPU 11 adds “1” to the document page and the page number respectively that were set in Step S46, and the new document page and the page number are thereby set (Step S49).

Next, the image control CPU 11 executes the page number creating program 11b2, and performs the setting for inserting the page number set at Step S49 onto the document image (called third document image hereinafter) corresponding to the document page set at Step S49 from among the document images stored in the image memory 15 (Step S50).

Next, the image control CPU 11 executes the sheet number creating program 11b3, and performs the setting for inserting the sheet number set at Step S41 (or Step S59) onto the third document image (Step S51).

Next, the image control CPU 11 adds “1” to the document page and the page number respectively that were set in Step S49, and the new document page and the page number are thereby set (Step S52).

Next, the image control CPU 11 executes the page number creating program 11b2, and performs the setting for inserting the page number set at Step S52 onto the document image (called fourth document images hereinafter) corresponding to the document page set at Step S52 from among the document images stored in the image memory 15 (Step S53).

Next, the image control CPU 11 executes the sheet number creating program 11b3, and performs the setting for inserting the sheet number set at Step S41 (or Step S59) onto the fourth document image (Step S54).

Next, the image control CPU 11 executes the generation program 11b1 and obtains document images which are the first document image, the second document image, the third document image and the fourth document image from the image memory 15 via the DRAM control IC 16, and generates the multiple-up images in which the first to fourth document images are collected (Step S55).

Next, the image control CPU 11 executes the composition program 11b4, and composes composite images in which the page number and the sheet number are inserted on the multiple-up images (Step S56).

Specifically, the composite image that was composed at Step S56 include; multiple-up images generated at Step S55; a page number inserted on the first document image of the multiple-up images (page number set at Step S44) and a sheet number (sheet number set at Step S45); and a page number inserted on the second document image of the multiple-up images (page-number set at Step S47) and a sheet number (sheet number set at Step S48); a page number inserted on the third document image of the multiple-up images (page number set at Step S50) a sheet number (sheet number set at Step S51); a page number inserted on the fourth document image of the multiple-up images (page number set at Step S53) and a sheet number (sheet number set at Step S54).

Next, the image control CPU 11 outputs the composite image composed in Step S56 to the image forming section 41 of the printer section 40 via the write processing section 17, and then sends instructions to the printer controller 40a and then the composite image is formed on the transfer paper at the image formation section 41 and then output (Step S57).

Next the image control CPU 11 makes a determination as to whether all the document images that were read in Step S4 (FIG. 13) have been formed and output (Step S58).

If a determination is made in Step S58 that not all the document images that were read have been formed and output (No in Step S58), the image control CPU 11 adds “1” to the document page and the page number set in Step S52 and the sheet number set in Step S41 (or in Step S59) respectively, and the new document page, page number and sheet number are thereby set (Step S59), and the processing from Step S42 is repeated.

On the other hand if a determination is made in Step S58 that all the document images that were read have been formed and output (Yes in Step S58), the image control CPU 11 ends the processing.

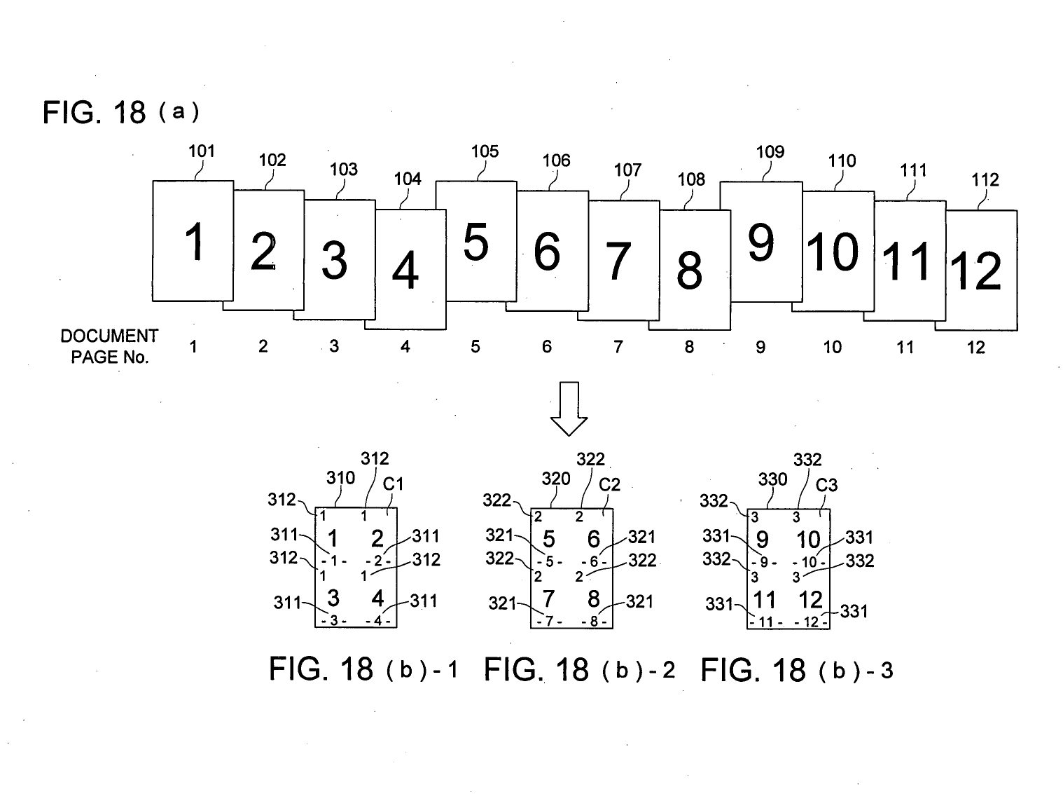

If for example, the document images are read from the documents shown in FIG. 18(a) (documents 101-112) in Step S4 (FIG. 13), transfer paper (sheets 310, 320 and 330) on which composite images such as those shown in FIGS. 18(b)-1 to 18(b)-3 are printed, are output in the second processing (FIG. 17) relating to the formation and output of composite images in the copier 1.

Specifically, in the FIGS. 18(b)-1 to 18(b)-3, page numbers (page number 311, 321, 331) corresponding to the document page of the document image are inserted on each document image of the multiple-up images (multiple-up images C1, C2, C3). Further, sheet numbers (sheet numbers 312, 322, 332) are inserted corresponding to the order in which the multiple-up images that are formed on the transfer paper and output, are inserted on each document image in the multiple-up images (multiple-up images C1, C2, C3).

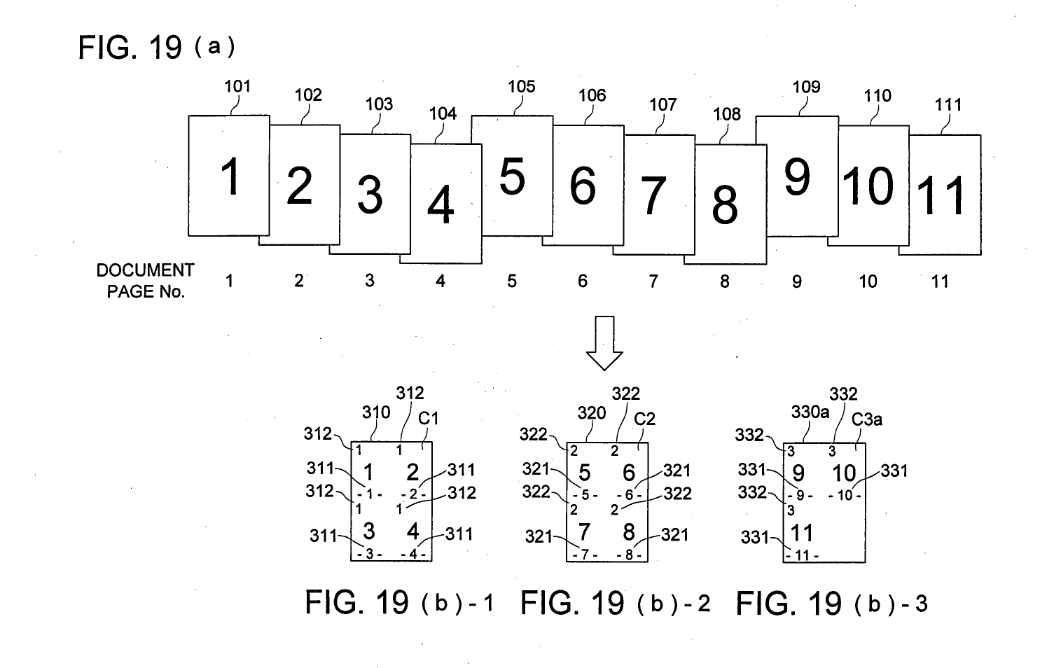

In addition if the document images are read from the documents (documents 101-111) shown in FIG. 19(a) in Step S4 (FIG. 13), transfer paper (sheets 310, 320 and 330a) on which composite images such as those shown in FIGS. 19(b)-1 to 19(b)-3 are printed, are output in the second processing (FIG. 17) relating to the formation and output of composite images in the copier 1.

It is to be noted that in FIG. 19(a) the number of document images is not a multiple of “4 (collected number). That is to say, the number of document images is “11” and because the number document images corresponding to document page “12” does not exist, the processing of Step S52 to Step S54 are omitted in the second processing (FIG. 17) related to the formation and output of the composite image in a copier 1, and in the processing of Step S55, the multiple-up images in which the first to third document images are collected is generated.

Specifically, in FIGS. 19(b)-1 to 19(b)-3, page numbers (page number 311, 321, 331) corresponding to the document page of the document image are inserted on the document images of the multiple-up images (multiple-up images C1, C2, C3a). Further, sheet numbers (sheet numbers 312, 322, 332) corresponding to the order in which the multiple-up images are formed on the transfer paper and output, are inserted at one positions of the collected document image (multiple-up images C1, C2, C3).

In the copier 1 of the invention described above, multiple-up images in which a preset collection number of multiple document images are collected can be generated by the image control CPU 11 which executed the generation program 11b1, and setting can be done for inserting page numbers corresponding to the document page of the document image onto each document image of the multiple-up images generated by the image control CPU 11 which executed the generation program 11b2 and the image control CPU 11 which executed the generation program 11b1, and setting can be done for inserting sheet numbers corresponding to the order in which the multiple-up images that are formed on the transfer paper and output, are inserted on the multiple-up images generated by the image control CPU 11 which executed the generation program 11b3 and a the image control CPU 11 which executed the generation program 11b1. Further, composite images can be composed on which a page number set by the image control CPU 11 which executed the generation program 11b2 and the sheet number set by the image control CPU 11 which executed the generation program 11b3 are inserted on the multiple-up images generated by the image control CPU 11 which executed the generation program 11b4 and the image control CPU 11 which executed the generation program 11b1. The composite image composed by the image control CPU 11 which executed the generation program 11b4 are formed on transfer paper and output using the printer section 40.

That is to say, composite images comprising multiple-up images in which document images are collected, page numbers corresponding to the document page of the document image, and sheet numbers corresponding to the order in which the multiple-up images are formed on the transfer paper and output can be formed and output. Thus, the page number can be used to determine on which sheet the document image from which number page of the document will be formed and output, and the sheet number can be used to determine which document image will be formed and output on what number sheet in the output sequence. That is to say a clearer determination can be made as to which document image will be formed and output on which sheet. As a result, trouble involved in searching for a desired document image or managing the number of sheets output is eliminated.

In addition, the operator can choose to insert a sheet number at one position of the multiple-up images or insert the page number on each document image of the multiple-up images by operating the touch panel (not shown) of the operation section 30. That is to say, the operator may select the number of sheet numbers to be inserted on the collected document image. Thus composite images designed based on the preference of the operator can be formed on the transfer paper and output.

In addition, the operator can operate the touch panel (not shown) of the operation section 30 and the insertion position of the sheet number to be inserted on the multiple-up images can be selected. Thus composite images having a layout based on the preference of the operator can be formed on the transfer paper and output.

It is to be noted that this invention is not limited to above described embodiments, and various modifications may be made without departing from the thrust of the invention.

The image forming device is not limited to the copier 1, and can be any device in which multiple-up images in which document images are collected, are formed on transfer paper and output and examples thereof include facsimiles and the like.

In addition, the document images are read from documents, but they may also be received from external devices.

The copier 1 includes the controller 10 as the image forming apparatus, but it may also include a PC (personal computer) and the like.

Specifically, the PC or the like may include programs for realizing at the CPU: a function for generating a function (equivalent to the “function realized by the image control CPU 11 executing the composition program 11b1 in the embodiment) for generating collected page images (equivalent to the “multiple-up images” of the embodiment) in which a preset collection number of multiple page images (equivalent to the “document image” of the embodiment) are collected; function (equivalent to the “function realized by the image control CPU 11 executing the page number creating program 11b2 in the embodiment) for performing setting for inserting page numbers corresponding to the page image on each page image in the collected page images that was generated; a function (equivalent to the “function realized by the image control CPU 11 executing the page number creating program 11b3 in the embodiment) for performing setting for inserting collected page numbers (equivalent to the sheet number in the embodiment) corresponding to the order in which the collected page images are generated, onto the collected page image that was generated; a function (equivalent to the “function realized by the image control CPU 11 executing the composition program 11b4 in the embodiment) for composing composite images comprising the collected page image that was generated, the page number that was set, and the collected page number that was set.

More specifically, the PC or the like may include applications (such as conversion software) having the abovementioned programs and the composition image including the page number and the collected page number may be composed by the PC or the like. In addition, the PC or the like may include a printer diver or the like having the above mentioned programs and the composite images including the page numbers and the collected page numbers may be composed by the PC or the like and then sent to a copier or a printer, and the composite images are formed on transfer paper by the copier or the printer and then output.

In the first processing (FIG. 14), relating to the formation and output of the composite image in the copier 1 and the second processing (FIG. 17), relating to the formation and output of the composite image in the copier, the example is given in which the collection number is “4”, but the collection number is not limited to “4” any number that can be set at the copier 1 may be suitably selected. Of course the description and the flowcharts (FIG. 14 and FIG. 17) are changed appropriately based on the set collection number.

The manner for inserting the page number and the sheet number is not limited to those in FIGS. 15, 16, 18, and 19, and may be suitably selected provided that it can be set at the copier 1.

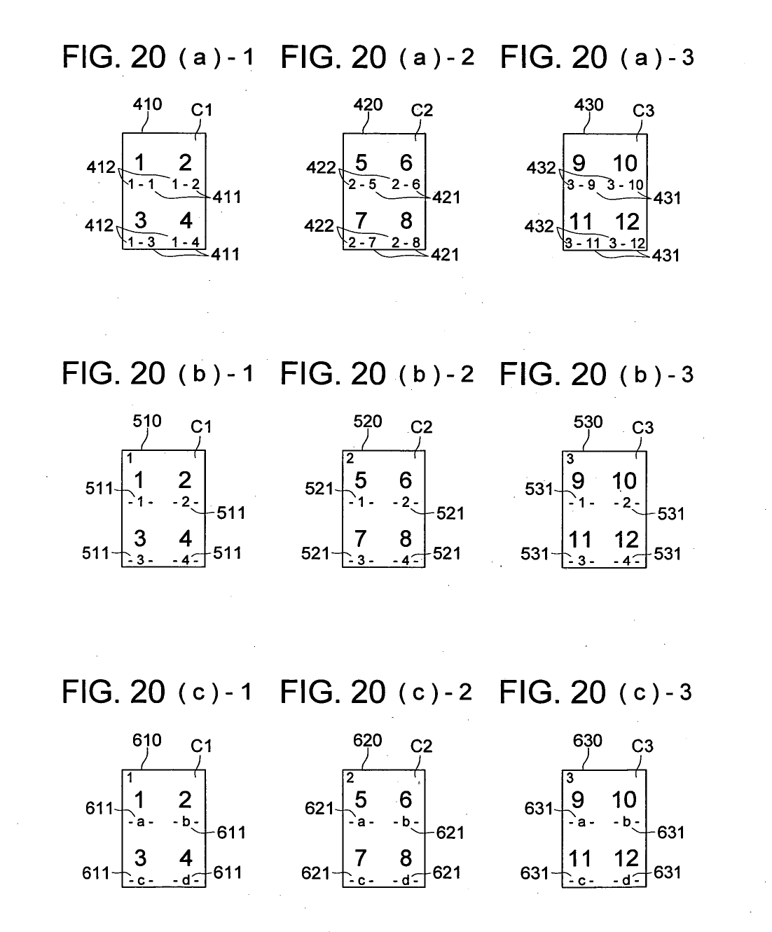

Further, as is the case with the composite image printed on the transfer paper (sheet 410, 420, and 430) shown in FIG. 20(a)-1 and FIG. 20(a)-3, marks, for example, the sheet numbers (sheet numbers 412, 422, and 432) and (page numbers 411, 421, and 431) may be connected by a hyphen and inserted on multiple-up images (multiple-up images C1, C2 and C3).

Also, the page number does not need to be the document page of the document image itself, as long as the page number corresponds with the document page of the document image. That is to say, the page numbers do not need to number all the document images that were read sequentially, as long as they are in order of the document pages. Specifically, as is the case with the composite images printed on the transfer paper (sheets 510, 520 and 530) shown in FIGS. 20(b)-1 to 20(b)-3, marks, for example, the page numbers (page number 511, 521 and 531) may be numbered sequentially for each sheet. Further, as is the case with the composite images printed on the transfer paper (sheets 610, 620 and 630) shown in FIGS. 20(c)-1 to 20(c)-3, marks, for example, the page numbers corresponding to document pages may be signs such as alphabets (alphabet 611, 621 and 631).

The method for generating the collected document image and the method for inserting the page number and the sheet number are not limited to those in the description of the embodiment, and as a result they may be suitably selected provided that the collected image documents, the page number and the sheet number are formed on the transfer paper and output.

In an embodiment of this invention, a composite image including multiple-up images in which document images are collected; page numbers corresponding to the document page of the document image, and a sheet number corresponding to the order in which the multiple-up images are formed on the transfer paper and output can be formed on transfer paper and output. Thus, the page number can be used to determine which sheet the document image on what number page of the document will be formed and output on, and the sheet number can be used to determine which document image will be formed and output on what number sheet in the output sequence. That is to say a clearer determination can be made as to which document image will be formed and output on which sheet. As a result, trouble involved in searching for a desired document image or keeping track of the number of sheets output is eliminated.

In an embodiment of this invention, a composite image in which page numbers corresponding to the document page of the document image, and a sheet number corresponding to the order in which the multiple-up images are formed on the transfer paper and output are inserted on the collected image documents in which image documents are collected, can be formed on transfer paper and output. Thus, the page number can be used to determine which sheet the document image on what number page of the document will be formed and output, and the sheet number can be used to determine which document image will be formed and output on what number sheet in the output sequence. That is to say a clearer determination can be made as to which document image will be formed and output on which sheet. As a result, trouble involved in searching for a desired document image or managing the number of sheets output is eliminated.

In an embodiment of this invention, the operator may select the number of sheet numbers to be inserted on the collected document image. Thus composite images designed based on the preference of the operator can be formed on the transfer paper and output.

In an embodiment of this invention, the operator can select the position of the sheet number to be inserted on the multiple-up images. Thus composite images having a layout based on the preference of the operator can be formed on the transfer paper and output.

In an embodiment of this invention, a composite image can be composed which includes collected page images in which page images are collected; page numbers corresponding to the page image, and collected page numbers corresponding to the order in which the collected page images are generated. Thus, the page number and the collected page number can be used to determine which page images were collected on which collected pages. As a result, trouble involved in searching for a desired page image or keeping track of the total number of collected page images is eliminated.

What is claimed is:

1. An image forming apparatus comprising:
a creating section which creates a multiple-up image to be printed on a sheet from a plurality of document, wherein the multiple-up image having a plurality of marks corresponding to one document and a sheet number corresponding to order of outputting a sheet; and
an image printing section which prints the multiple-up image on a sheet.

2. The image forming apparatus of claim 1, wherein the mark is a page number of the document.

3. The image forming apparatus of claim 1, wherein the mark is a combination of a page number of the document and the sheet number.

4. The image forming apparatus of claim 1, wherein the mark is a page number of the document, wherein the page number is sequence number in one sheet.

5. The image forming apparatus of claim 1, wherein the sheet number creating section which creates a sheet number to each document in the multiple-up image.

6. The image forming apparatus of claim 1, wherein the mark is an alphabet.

7. An image forming apparatus comprising:
a creating section which creates a multiple-up image to be printed on a sheet from a plurality of document;
a mark creating section which creates a plurality of marks corresponding to one document;
a sheet number creating section which creates a sheet number corresponding to order of outputting a sheet;
a combining section which combines the multiple-up image, the mark and the sheet number to form a composite image; and
an image printing section which prints the composite image combined by the combining section on a sheet.

8. The image forming apparatus of claim 7, wherein the sheet number creating section comprising:
a first sheet number creating section which creates a sheet number at one space in the multiple-up mage;
a second sheet number creating section which creates a sheet number to each document in the multiple-up image;
a selecting section which selects a sheet number of the first sheet number creating section or the second number creating section.

9. The image forming apparatus of claim 7, further comprising:
a position selecting section which selects a position of the sheet number.

10. The image forming apparatus of claim 7, wherein the mark is a page number of the document.

11. The image forming apparatus of claim 1, wherein the mark is a combination of a page number of the document and the sheet number.

12. The image forming apparatus of claim 1, wherein the mark is a page number of the document, wherein the page number is sequence number in one sheet.

13. The image forming apparatus of claim 1, wherein the sheet number creating section which creates a sheet number to each document in the multiple-up image.

14. The image forming apparatus of claim 1, wherein the mark is an alphabet.

15. An image processing apparatus comprising:
a creating section which creates a multiple-up image to be printed on a sheet from a plurality of document;
a mark creating section which creates a plurality of marks corresponding to one document;
a sheet number creating section which creates a sheet number corresponding to order of outputting a sheet; and
a combining section which combines the multiple-up image, the mark and the sheet number to form a composite image.

16. The image forming apparatus of claim 15, wherein the mark is a page number of the document.

17. The image forming apparatus of claim 15, wherein the mark is a combination of a page number of the document and the sheet number.

18. The image forming apparatus of claim 15, wherein the mark is a page number of the document, wherein the page number is sequence number in one sheet.

19. The image forming apparatus of claim 15, wherein the sheet number creating section which creates a sheet number to each document in the multiple-up image.

20. The image forming apparatus of claim 15, wherein the mark is an alphabet.
